(19) United States
(12) Patent Application Publication
(10) Pub. No.: US 2015/0178624 A1
(43) Pub. Date: Jun. 25, 2015

(54) ELECTRONIC SYSTEM WITH PREDICTION MECHANISM AND METHOD OF OPERATION THEREOF

(71) Applicant: SAMSUNG ELECTRONICS CO., LTD., GYEONGGI-DO (KR)

(72) Inventors: Wei-Meng Chee, Sunnyvale, CA (US); Paul Dixon, Redwood City, CA (US); Katherine Marie Hayden, Sunnyvale, CA (US)

(73) Assignee: SAMSUNG ELECTRONICS CO., LTD., GYEONGGI-DO (KR)

(21) Appl. No.: 14/138,293

(22) Filed: Dec. 23, 2013

(51) Int. Cl. G06N 5/04; G06K 9/62

(52) U.S. Cl. CPC G06N 5/04; G06K 9/6217

(57) ABSTRACT

A method of operation of an electronic system includes: capturing an image; recording an input associated with the image; capturing an updated image; and invoking an agent, with a control unit, associated with the updated image based on the input associated with the image.

### TECHNICAL FIELD

An embodiment of the present invention relates generally to an electronic system, and more particularly to a system for prediction.

### BACKGROUND

Modern consumer and industrial electronics, especially devices such as graphical devices, televisions, projectors, cellular phones, portable digital assistants, and combination devices, are providing increasing levels of functionality to support modern life. Research and development in the existing technologies can take a myriad of different directions.

These electronic devices are increasing “smart” by providing utility for users and particularly mobile users. The “smart” utilities are for the most part provided by applications installed on the “smart” devices. The applications are focused on specific information within subject-matter bounded data and application bounded data to provide “smart” information.

These applications for the “smart” devices can provide user customization including single-task agents or “bots” that perform a defined task when a specific condition is reached such as an email when particular shoes become available in a specific size or when a plane ticket price reaches a specific limit. Other applications can include reinforcement learning systems such as music services can attempt to only play songs by discerning the musical features of songs given a thumbs up or thumbs down. Yet other applications can include demographic research on network effects on individual behavior.

Thus, a need still remains for an electronic system including prediction mechanisms for user customization. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system, including: a communication unit configured to capture an image; a user interface, coupled to the communication unit, configured to record an input associated with the image; a storage unit, coupled to the user interface, configured to capture an updated image; and a control unit, coupled to the storage unit, configured to invoke an agent associated with the updated image based on the input associated with the image.

An embodiment of the present invention provides a method of operation of an electronic system including: capturing an image; recording an input associated with the image; capturing an updated image; and invoking an agent, with a control unit, associated with the updated image based on the input associated with the image.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an electronic system with prediction mechanism in an embodiment of the present invention.

FIG. 2 is an example of a display interface of the first device of FIG. 1.

FIG. 3 is an exemplary block diagram of the electronic system in an embodiment of the present invention.

FIG. 4 is a control flow of the electronic system in an embodiment of the present invention.

FIGS. 5A to 5E are shown additional details of modules of the electronic system 100 in embodiments of the present invention.

FIG. 6 is a control flow for a tuning loop of the electronic system in an embodiment of the present invention

FIG. 7 is a flow chart of a method of operation of an electronic system in an embodiment of the present invention.

### DETAILED DESCRIPTION

An embodiment of the present invention includes an electronic system at least configured to capture a user image that can be associated with a user input or activity to invoke an agent that intelligently acts on the user's behalf.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “image” referred to herein can include a two-dimensional image, three-dimensional image, video frame, a computer file representation, an image from a camera, a video frame, or a combination thereof. For example, the image can be a machine readable digital file, a physical photograph, a digital photograph, a motion picture frame, a video frame, an x-ray image, a scanned image, or a combination thereof.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

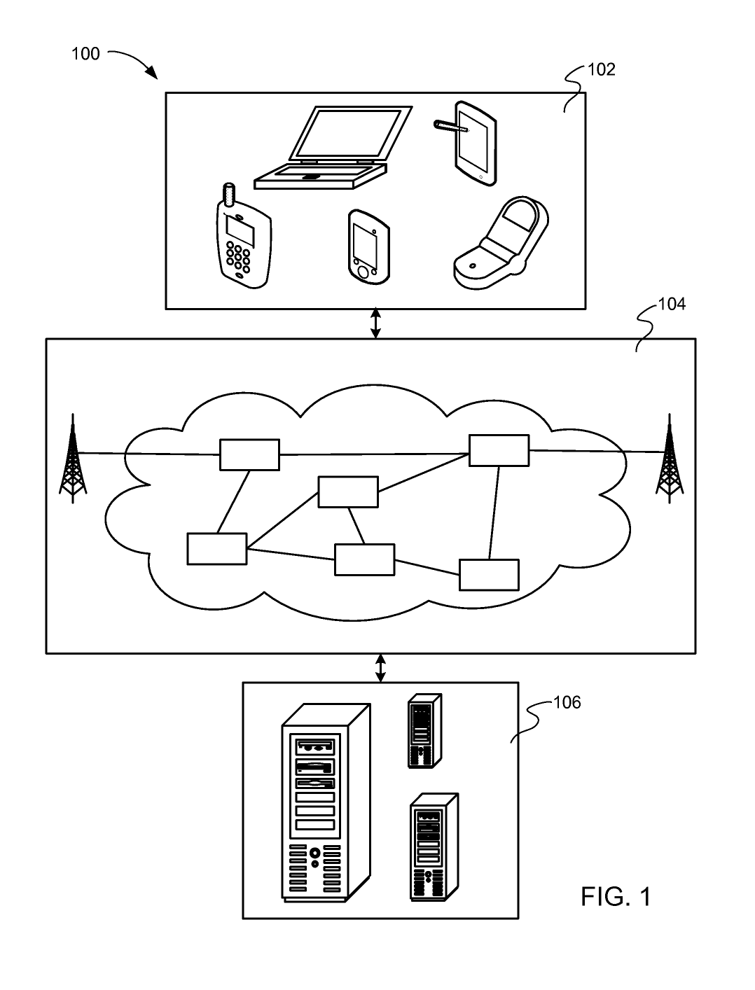

Referring now to FIG. 1, therein is shown an electronic system 100 with prediction mechanism in an embodiment of the present invention. The electronic system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, a notebook computer, a liquid crystal display (LCD) system, a light emitting diode (LED) system, or other multi-functional display or entertainment device. The first device 102 can couple, either directly or indirectly, to the communication path 104 to communicate with the second device 106 or can be a stand-alone device.

For illustrative purposes, the electronic system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a Digital Video Disk (DVD) player, a three-dimension enabled DVD player, a recording device, such as a camera or video camera, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the electronic system 100 is described with the second device 106 as a computing device, although it is understood that the second device 106 can be different types of devices. Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth®, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

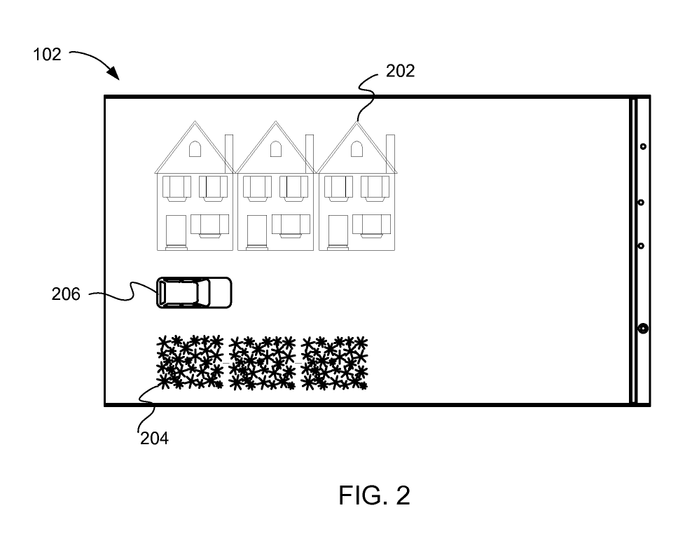

Referring now to FIG. 2, therein is shown an example of a display interface 210 of the first device 102 of FIG. 1. The display interface 210 can include an image of a task, an event, a point of interest, previously visited locations, directions to the aforementioned, a music playlist, a multimedia program, items for purchase, services for purchase, contact information, images related to the aforementioned, or combination thereof.

The display interface 210 can also provide images, information, or data for a prediction of a user goal as well as images, information, or data resulting from the prediction of the user goal. Data or activity input can be confirmed or facilitated by the display interface 210. Further, optional confirmation or options can displayed on the display interface 210 associated with proactive actions based on the prediction of the user goal.

For illustrative purposes the display interface 210 is shown with images including buildings 202, plants 204, and an automobile 206 are shown although it is understood that the image may be different. The display interface 210 can include any image such as playlists, items, artwork, programs, or combination thereof.

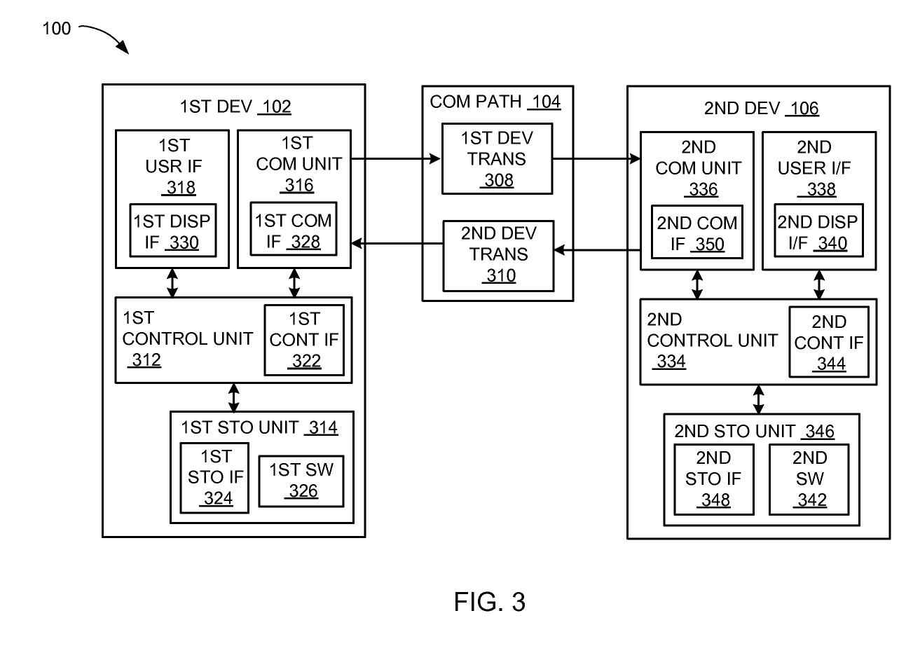

Referring now to FIG. 3, therein is shown an exemplary block diagram of the electronic system 100 in an embodiment of the present invention. The electronic system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the electronic system 100 is shown with the first device 102 as a client device, although it is understood that the electronic system 100 can have the first device 102 as a different type of device. For example, the first device 102 can be a server having a display interface.

Also for illustrative purposes, the electronic system 100 is shown with the second device 106 as a server, although it is understood that the electronic system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 312, a first storage unit 314, a first communication unit 316, and a first user interface 318. The first control unit 312 can include a first control interface 322. The first control unit 312 can execute a first software 326 to provide the intelligence of the electronic system 100.

The first control unit 312 can be implemented in a number of different manners. For example, the first control unit 312 can be a processor, an application specific integrated circuit (ASIC) an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations external to the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The first storage unit 314 can store the first software 326. The first storage unit 314 can also store the relevant information, such as data representing incoming images, data representing previously presented image, sound files, or a combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106 of FIG. 1, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user (not shown) to interface and interact with the first device 102. The first user interface 318 can include an input device and an output device. Examples of the input device of the first user interface 318 can include a keypad, a touchpad, soft-keys, a keyboard, a microphone, an infrared sensor for receiving remote signals, or any combination thereof to provide data and communication inputs.

The first user interface 318 can include a first display interface 330. The first display interface 330 can include a display, a projector, a video screen, a speaker, or any combination thereof.

The first control unit 312 can operate the first user interface 318 to display information generated by the electronic system 100. The first control unit 312 can also execute the first software 326 for the other functions of the electronic system 100. The first control unit 312 can further execute the first software 326 for interaction with the communication path 104 via the first communication unit 316.

The second device 106 can be optimized for implementing an embodiment of the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second device 106 of the electronic system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the electronic system 100, including operating the second communication unit 336 to communicate with the first device 102 over the communication path 104.

The second control unit 334 can be implemented in a number of different manners. For example, the second control unit 334 can be a processor, an embedded processor, a microprocessor, hardware control logic, a hardware finite state machine (FSM), a digital signal processor (DSP), or a combination thereof.

The second control unit 334 can include a second controller interface 344. The second controller interface 344 can be used for communication between the second control unit 334 and other functional units in the second device 106. The second controller interface 344 can also be used for communication that is external to the second device 106.

The second controller interface 344 can receive information from the other functional units or from external sources, or can transmit information to the other functional units or to external destinations. The external sources and the external destinations refer to sources and destinations external to the second device 106.

The second controller interface 344 can be implemented in different ways and can include different implementations depending on which functional units or external units are being interfaced with the second controller interface 344. For example, the second controller interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the such as data representing incoming images, data representing previously presented image, sound files, or a combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the electronic system 100 is shown with the second storage unit 346 as a single hierarchy storage system, although it is understood that the electronic system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to the second device 106.

The second storage interface 348 can include different implementations depending on which functional units or external units are being interfaced with the second storage unit 346. The second storage interface 348 can be implemented with technologies and techniques similar to the implementation of the second controller interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second controller interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The electronic system 100 can be executed by the first control unit 312, the second control unit 334, or a combination thereof. For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the electronic system 100 is described by operation of the first device 102 and the second device 106. It is understood that the first device 102 and the second device 106 can operate any of the modules and functions of the electronic system 100.

The modules described in this application can be part of the first software 226 of FIG. 2, the second software 242 of FIG. 2, or a combination thereof. These modules can also be stored in the first storage unit 214 of FIG. 2, the second storage unit 246 of FIG. 2, or a combination thereof. The first control unit 212, the second control unit 234, or a combination thereof can execute these modules for operating the electronic system 100.

The electronic system 100 has been described with module functions or order as an example. The electronic system 100 can partition the modules differently or order the modules differently. For example, a data module can include an image module, an input module, and a multimedia module as separate modules although these modules can be combined into one. Also, a prediction module can be split into separate modules for implementing in the separate modules. Similarly a resource module can be split into separate modules for each of navigation module, media module, or consumer module.

The modules described in this application can be hardware implementation, hardware circuitry, or hardware accelerators in the first control unit 212 of FIG. 2 or in the second control unit 234 of FIG. 2. The modules can also be hardware implementation, hardware circuitry, or hardware accelerators within the first device 102 or the second device 106 but outside of the first control unit 212 or the second control unit 234, respectively.

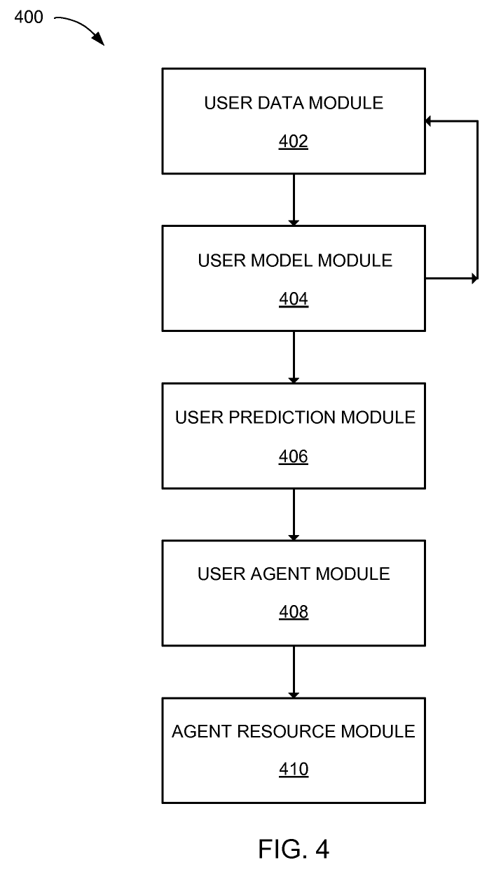

Referring now to FIG. 4, therein is shown a control flow 400 of the electronic system 100 in an embodiment of the present invention. The electronic system 100 includes a user data module 402 coupled to a user model module 404. The user data module 402 can include data mining associated with a user and provide additional data and updates to the user model module 404.

The data of the user data module 402 can include images, activities, input, network server data, social networking information, any user related data associated with the user, or combination thereof. For example, data input to the user data module 402 can include multimedia i.e. email, data from social networking sites, such as Facebook® entries from a user or others, changes in status from others, or combination thereof.

The user model module 404 can include user behavioral data including passively tracked behavior and user input data including actively given or input. The behavioral data and the user input data can provide training data for the user model module 404. Data sources can include the first device 102 or the second device 106, such as personal mobile devices and ubiquitous public sensors, from both real and virtual environments.

Mood data can also be included in the user model module 404. The mood data can be determined or at least inferred based on the data of the user data module 402, such as images including images of the user, activities including selections among options, activity including text input, related social networking data, or combination thereof.

A user prediction module 406 can provide predictions based on a model of the user model module 404. The predictive power of the model comes at least from blending the model, including personal agent model history, with the user related data, including relevant demographic statistics and heuristics. The user prediction module 406 can also appropriately weight and choose one of conflicting goals when predicting or choosing actions.

For example, each goal such as “Drive to theater from current location and arrive by 6 PM” can be given a priority ranking such as 4 out of 5 by the user when they goal is first made. When two goals conflict such as “Drive to theater . . . ” with priority level of 4 and “Drive to UPS store” with priority level of 3, the goal with the higher priority can be chosen. In this case the user prediction module 406 would choose the goal of “Drive to the theater” and take appropriate actions on behalf of that goal, such as displaying or pulling up driving directions and setting a departure time alarm based on up-to-date traffic conditions with an estimated drive time.

Further to the example, the user prediction module 406 can optionally take action on the lower priority goal, whether user-specified such as “Send request to partner's calendar to take ownership of ‘UPS pickup’” or system-reasoned, including predicted by the electronic system 100, such as “Send notification text to all others attending event if the number of attendees is under 5.”

The user prediction module 406 can also provide predictions using a combination of a user's past activity and a demographic group's likely activity. For example, if a user first interacts with the user's smartphone at 6:50 am every morning with 80% certainty, but historical evidence shows that this user's demographic group has a 90% chance to first interact with a smartphone at 10:15 am on a specific holiday morning, user prediction module 406 can predict that the user will first interact with the user's smartphone on that specific day approximately 3 hours and 25 minutes later than normal. This low-level sensor data knowledge can be translated into higher level predictions such as “The user is sleeping in.”

As another example, the user prediction module 406 can predict user behavior through a combination of history of user behavior, such as “User X frequently listens to music by Elliott Carter”, and demographic information, such as “Users who listen to Elliott Carter also frequently listen to György Ligeti and Igor Stravinsky”. The user prediction module 406 can provide a prediction, such as “User X would/will listen to Ligeti and Stravinsky”, and undertake informed actions, such as “When user X is in the context appropriate to listen to atonal music and also in the mood to listen to composers besides their regular favorites, cue up Ligeti and Stravinski”.

The user prediction module 406 can balance conflicting goals. For example, conflicting goals can include deciding between possible actions, such as “User wants to be introduced to wide new range of music” versus “At this moment it would be most appropriate to play familiar song Y which bolsters user's resolve to complete a rote, unpleasant task”.

The user prediction module 406 can infer a goal of a particular mood such as relaxed, happy, or any other mood based on images, user input, user setting, or combination thereof. Learning based on data from the user data module 402 can also provide a basis to discover inconsistent input such as facial recognition inconsistent with mood or behavior. The user prediction module 406 can provide predictions or act based on a combination of moods, goals and resources.

An agent of the user prediction module 406 or a user agent module 408 can determine mood and predict or recommend actions to encourage divergence from a user “rut” or to react to undesirable moods or states. The user model module 404, the user prediction module 406, or a user agent module 408 can keep track of the user goals, resources, current mood, and historical moods caused by certain actions.

Keeping track of user information can improve correlation of mood trends with behavior trends such as “Listening to an artist like Elliott Smith with music tags including “brooding” and “melancholy” subsequently causes the user to describe their mood as “sad” and “gloomy.””. If the user has a goal to reach a mood they describe as “happy”, “inspired”, or combination thereof, the user model module 404, the user prediction module 406, or the user agent module 408 can find music the user has labeled with synonymous tags or music the user has historically played before describing the particular mood of the goal.

The user model module 404, the user prediction module 406, or the user agent module 408 can include additional utility or sophistication with effective transitions for a given user. For example tracking data or patterns can indicate that to achieve a goal state a more effectual process includes first matching the user's current emotional state in musical selection and then playing songs that progressively move towards the goal state.

The user agent module 408 can include a multi-agent system that intelligently acts on a user's behalf at least by taking into account the user's mood including emotional and physical state, activity, short and long-term goals, and resources. The user model can be constantly updated in real-time by the user's activity in real and virtual environments. High-level concepts such as relationship intensity and emotional state can be modeled as well as low-level concepts such as the user's current location, which can include latitude and longitude.

The user agent module 408 coupled to the user model module 404 can act on the user's behalf to execute tasks. The user model module 404, the agent resource module 410, or combination thereof can include software providing at least “concierge” service, or user “double” service to act on a user's behalf. The user “double” service can be based on behavioral mapping of many digital details.

An agent resource module 410, coupled to the user agent module 408, can provide access to resources such as activities including playing music, consumption of “something”, travel directions to a location. The user agent module 408 can implement to enable actions on behalf of a user with access to resources by the agent resource module 410.

The electronic system 100 can incorporate and integrate aspects of software-based multi-agent frameworks, intelligent collaborative learning systems, affective computing, ubiquitous and mobile computing, and population demographic models. Incorporating and integrating aspects of the multi-agent frameworks can enable the electronic system 100 to proactively act on behalf of the user in an informed and highly tailored way, based on a constantly-learning agent-based model of the user.

The electronic system 100 can also execute tasks from a device such as the first device 102, the second device 106, a networked device connected to the communication path 104, or combination thereof. For example, a user can register a Bluetooth® link to other devices such as a home speaker system so that whenever the device is within range of this speaker system, the device has increased functionality, in this case the option to play from the mobile phone speakers or the home speaker system. The user can also set defaults such as “Always immediately switch the sound to the home speaker system when within range”.

The electronic system 100 can optionally be implemented as a server-based application. For example, the server-based application can enable using only a small client application. Further, the server-based application can store more data, models, or combination thereof to provide improved selection of the best of different models, and facilitate multi-detection “points”.

It has been discovered that the electronic system 100 with the user data module 402, the user model module 404, the user prediction module 406, and the user agent module 408, provides the combination of a mobile-based multi-agent framework with a constantly-updating real-time model of the user and different affective technologies into a combined system allowing for intelligent task execution informed by multiple data sources and data types.

Further it has been discovered that the electronic system 100 with the user data module 402, the user model module 404, the user prediction module 406, and the user agent module 408, provides predictive power of the model at least from blending personal agent model history with relevant demographic statistics and heuristics.

Yet further it has been discovered that the electronic system 100 with the user data module 402, the user model module 404, the user prediction module 406, the user agent module 408, and the agent resource module 410, provides highly accurate modeling, prediction, and agents. The high accuracy of the electronic system 100 requires constant monitoring and reevaluation of models for user and demographic groups provided by current technologies of modern computing and application systems.

The electronic system 100 has been described with module functions or order as an example. The electronic system 100 can partition the modules differently or order the modules differently. For example, the user model module 404 can connect directly to the user agent module 408 particularly when a prediction is not required. Further the user data module 402 may connect directly to the user prediction module 406 and can optionally provide updates to the user model module 404.

The modules described in this application can be hardware implementation or hardware accelerators in the first control unit 316 of FIG. 3 or in the second control unit 338 of FIG. 3. The modules can also be hardware implementation or hardware accelerators within the first device 102 or the second device 106 but outside of the first control unit 316 or the second control unit 338, respectively.

The physical transformation from network data results in the movement in the physical world, such as user travel, user viewing a display, user listening to audio, or combination thereof. Movement in the physical world such as user facial expression, user input, or combination thereof results in changes to by user agent action including displaying activities, displaying travel instructions, displaying video, broadcasting audio, or combination thereof.

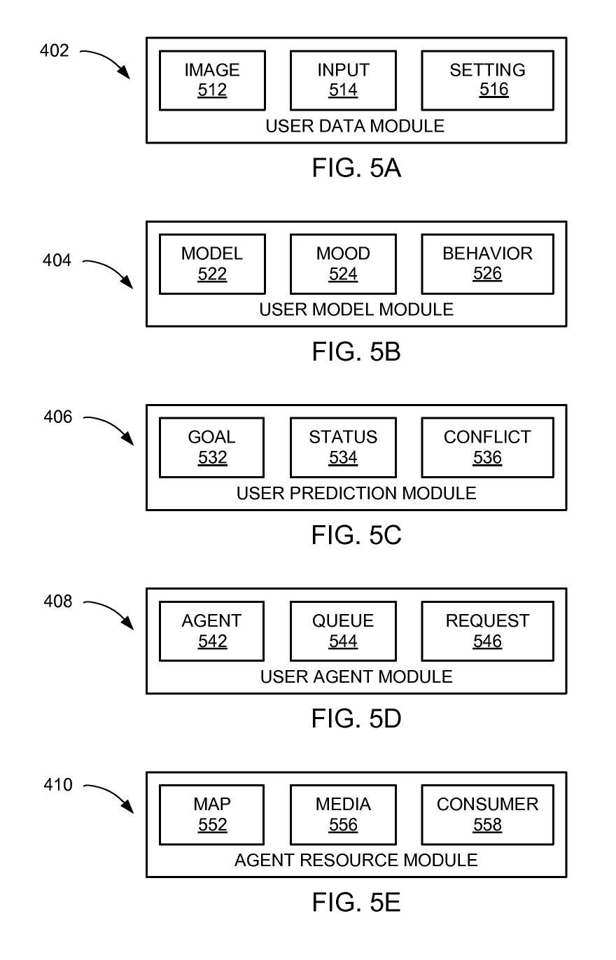

Referring now to FIGS. 5A to 5E, therein are shown additional details of modules of the electronic system 100 in embodiments of the present invention. The electronic system 100 with prediction mechanism can include the user data module 402, the user model module 404, the user prediction module 406, the user agent module 408, and the agent resource module 410.

Referring now to FIG. 5A, therein is shown the user data module 402 with additional details in embodiments of the present invention. The user data module 402 can include at least images 512 including user facial images, input 514 including user activity input, user setting 516 including location and surroundings, or combination thereof. The images 512, the input 514, the user settings 516, or combination thereof, can be created, captured, stored, or implemented through the first communication unit 316, the second communication unit 336, the first control unit 312, the second control unit 334, the first storage unit 314, the second storage unit 346, any interfaces contained therein, or combination thereof.

The user data module 402 can include gathering information about a user on another's device or a public device can be sent to the user's device and its corresponding model of the user. In the same way the user's browsing history is recorded across a browser such as “Google Chrome” when the user is logged into the browser on any computer, a device such as the first device 102 or the second device 106 can log or record an image of the user's facial expressions 512 when watching a movie such as on a shared screen and transmit that log back to the user's individual device.

The user model module 404 and the user data module 402 can include data and modeling of the user setting 516. The user setting 516 can include time of day, location, interaction, other users, or combination thereof. The user model module 404 can track any user settings 516 such as track user activity in both real-world environments and virtual environments.

Referring now to FIG. 5B, therein is shown the user model module 404 with additional details in embodiments of the present invention. The user model module 404 can include at least user models 522, user moods 524, and user behaviors 526 including passively tracked user behavior 526 and actively input user data, or combination thereof. The user models 522, the user moods 524, the user behaviors 526, or combination thereof, can be created, captured, stored, or implemented through the first communication unit 316, the second communication unit 336, the first control unit 312, the second control unit 334, the first storage unit 314, the second storage unit 346, any interfaces contained therein, or combination thereof.

The user model module 404 and the user data module 402 include continuous or constant learning based on a user both directly and indirectly with related behaviors 526 such as user or community behaviors 526. The learning can be implicit such as through tracking, explicit such as through user direction and training, or combination thereof. The continuous or constant learning can enable the user model module 404 and the user data module 402 to determine the user setting 516, the user models 522, the user moods 524, and the user behaviors 526, associated with or based on the image 512.

The user model module 404 coupled to the user data module 402 can include current and historical information. For example the user model module 404 can track current GPS location as well as all past locations including since owning phone, and can record GPS readings taken incrementally such as every 30 minutes.

The user model module 404 and the user data module 402 can include users' private activity or input 514, broadcasts and exchanges with other users ranging from physical to virtual environments including choosing songs with a service provider such as Spotify®, posting status with a social networking provider such as Facebook®, participating in a conversation with a social networking provider such as Facebook®, or combination thereof.

A device such as the first device 102 or the second device 106 operating the user model module 404 and the user data module 402 can continuously determine weighting of an interaction importance with respect to different time spans including short time spans (for example 5 min.), medium time spans (for example 1-3 hours), long time spans (for example 8 hours), a day span, a week span, a month span, or a year span.

The user model module 404 and the user data module 402 can include proximity including physical and virtual environments, of other users, resources, or combination thereof. The proximity can be specified as a range including distance, classification, content, or combination thereof. This range can be changed by the user including specifying which network effects to take into account or which network effects not to take into account. The device such as the first device 102 or the second device 106 can automatically detect new service providers or network sites that a user has become a part of such as Twitter® or a regular group of people who communicate regularly across various platforms.

For example, a player of an online multi-player game in the short to medium time span can have interactions in the virtual environment prioritized. Alternately a highly infrequent computer user, spending an average of 2 hours a week online, can have physical interactions, such as proximity of a device to other devices in a company office, weighted more heavily than the infrequent computer user's digital exchanges or interactions.

The user model module 404 and the user data module 402 can also include data and modeling based on the data based on input 514 directed from other users including invitations or broadcasts from the other users, environmental sensors including smoke or noise sensors in public or private locations, tweet streams of a trending topic including from a physical location like a concert, or combination thereof. The data and the modeling based on the data can also include related input 514 by other users from public or private network sources.

The user model module 404 can include consideration for network effects influencing user behavior 524 and device performance. The user model module 404 can track and predict a mood 524 or moods 524 of other users in proximity or upcoming proximity to a user for applying or considering an effect on a user's mood 524. For example, the user has a close relationship with three specific other users and the user interacts with each of the other users daily in the physical and virtual world. If one of these three other users has a dramatic, serious change in mood 524, or begins a consistent new pattern of traveling to a certain location, the other users change is highly likely to influence the user's behavior 524 in the same or similar manner.

The user model module 404 can include mood determination using data gathered in real-time from multiple sources such as user's and others' device (e.g. smart phone) with built-in sensors including cameras. The user model module 404 can include emotion-based recognition by using a camera to capture a facial expression including eye movements and facial characteristics. Thus determining the user mood 524 based on the image 512.

The user model module 404 can measure the user's mood 524 in at least two ways including categorizing static images 512 using Facial Action Coding System “FACS” and deconstructing the image 512 into specific Action Units “AU” of muscles activated or categorizing video segments using Essa and Pentland's templates for whole-face analysis of facial dynamics in motion using a spatio-temporal motion energy model, potentially more accurate but more resource-intensive.

As an example, using FACS, an agreed upon AU categorizations for emotions can include “happiness” with an AU of 6+12, “sadness” with an AU of 1+4+15, or “surprise” with an AU of 1+2+5B+26. Further, a subset of FACS could be also be implemented such as Emotional Facial Action Coding System “EMFACS” or Facial Action Coding System Affect Interpretation Dictionary “FACSAID” that considers only emotion-related facial actions.

As another example, using Essa and Pentland's templates a similarity score can be computed of a captured expression with a corrected facial motion energy template including templates for smile, surprise, raised eye brow, anger, disgust. Further, an AU can be extracted of a face from video sequences by generating a finite element mesh “FEM” over a face, and reducing the mesh into a 2D spatio-temporal motion energy representation to compare to expression templates. A Euclidean norm of the difference between two captured faces or expressions can be implemented to measure the similarity or dissimilarity.

Referring now to FIG. 5C, therein is shown the user prediction module 406 with additional details in embodiments of the present invention. The user prediction module 406 can include at least user goals 532 including explicit and inferred, user status 534 including user's current situation, a conflict module 536 configured to resolve competing or conflicting goals 532, solutions, or tasks based on the user model 522, or combination thereof.

The user goals 532, the user status 534, the conflict module 536, or combination thereof, can be created, captured, stored, or implemented through the first communication unit 316, the second communication unit 336, the first control unit 312, the second control unit 334, the first storage unit 314, the second storage unit 346, any interfaces contained therein, or combination thereof.

The user prediction module 406 coupled to the user model module 404 interprets user's goals 532 and intentions through a combination of the user input 514 and methods including the stated goals 532 such as “Arrive at home at 6:30 pm tonight”, past behavior under similar circumstances, pattern of traveling to a same location at a same time every evening, developing a set of heuristics that most likely capture user intentions based on observed activity 514 including likelihood of changes in a pattern or the behavior 526.

Thus the user prediction module 406 coupled to the user model module 404 can map real-world concepts including relationships, hierarchies, goals, emotions, or combination thereof. Interprets conceptual level information by interpreting physical structure of environments or settings 516. The mapping and interpretation can also incorporate other models 522 and interpretations such as statistics on musical tastes for a certain demographic, to explain and predict a user's mood 524 and goals 532.

Referring now to FIG. 5D, therein is shown the user agent module 408 with additional details in embodiments of the present invention. The user agent module 408 can include at least agents 542 including software agents configured to act on behalf of a user, a solution queue 544 preferably prioritizing solutions or agents 542 with the user prediction module 406, a user request module 546 configured to query a user based on the solution, or combination thereof.

The agents 542, the solution queue 544, the user request module 546, or combination thereof, can be created, captured, stored, or implemented through the first communication unit 316, the second communication unit 336, the first control unit 312, the second control unit 334, the first storage unit 314, the second storage unit 346, any interfaces contained therein, or combination thereof.

The user agent module 408 can include agents 542, a user request module 546. The user request module 546 can determine whether to provide a query to a user regarding implementing a solution including invoke the agent 542 if the solution is expensive. Alternatively the user request module 546 can act on behalf of the user to implement a solution or invoke the agent 542 without a query asking if the solution is inexpensive or a low sensitivity based on an inference or prediction.

Referring now to FIG. 5E, therein is shown the user resource module 410 with additional details in embodiments of the present invention. The agent resource module 410 can include at least map and navigation resources 552, multimedia resources 556, consumer product and service resources 558, or combination thereof.

The navigation resources 552, the multimedia resources 556, the consumer product and service resources 558, or combination thereof, can be created, captured, stored, or implemented through the first communication unit 316, the second communication unit 336, the first control unit 312, the second control unit 334, the first storage unit 314, the second storage unit 346, any interfaces contained therein, or combination thereof.

An agent resource module 410 can provide access for the user agent module 408 to resources such as the navigation resources 552, the multimedia resources 556, the consumer product and service resources 558, or combination thereof, for activities including playing music, consumption of goods or services, travel directions to a location, or combination thereof. The agent resource module 410 can enable access to resources for actions or agents 542 on behalf of a user. The agent 542 configured to access resources can be invoke on behalf of the user.

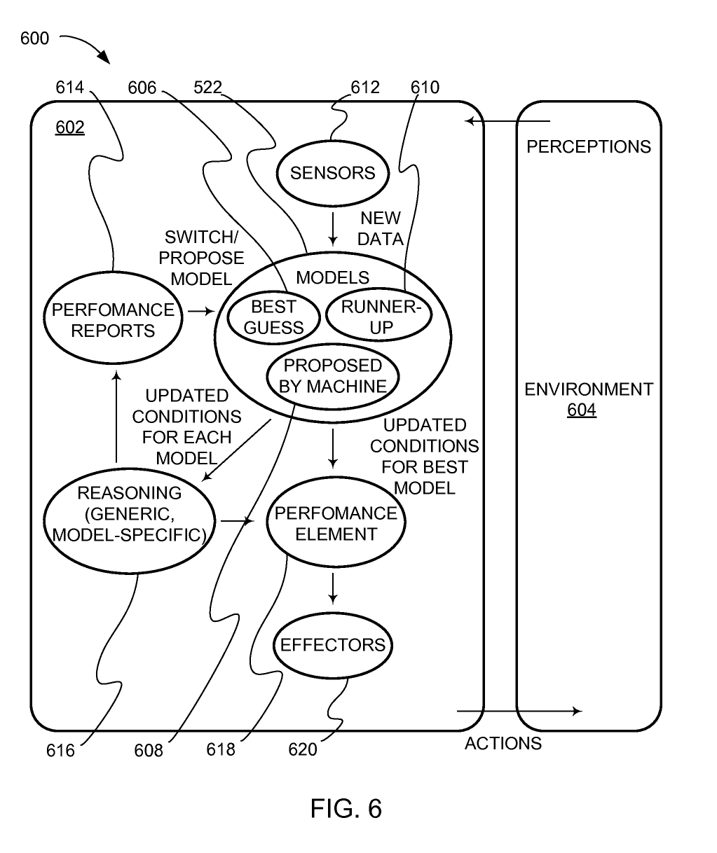

Referring now to FIG. 6, therein is shown a control flow 600 for a tuning loop of the electronic system 100 in an embodiment of the present invention. The control flow 600 can include a modeling module 602 interacting with a user environment 604. The modeling module 602 can be included in the user model module 404 of FIG. 4.

The modeling module 602 can include the user models 522, best guess models, machine proposed models 608, and runner-up models 610. The control flow 600 automatically switches between top best guesses 606 for the most accurate user model 522 based on performance of model 522 under current context. As an example the user status 534 of FIG. 5 is currently matching the best guess model 606 of “playing soccer rather than being in a meeting at work” so the control flow 600 switches the best guess model 606 to the user model 522.

The control flow 600 can implement “tuning loops” that model the user. The “tuning loops” iteratively check, test, and determine the most accurate user model 522. These “tuning loops” can infer priorities at least based on the user model 522 and the user prediction module 406 of FIG. 4. The behavior 526, including user behavior, other users behavior, general behavior, or combination thereof, can be applied with user assigned group(s) or demographics based at least on emergent data of the user data module 402, the user model 522, the user status 534 of FIG. 5, or combination thereof.

The control flow 600 can also include sensors 612 configured to provide data such as the images 512 of FIG. 5, the input 514 of FIG. 5, the settings 516 of FIG. 5, or combination thereof. The control flow 600 can also determine perceptions from the environment 604 based on the images 512, the input 514, or the settings 516. These perceptions can also provide data to the user prediction module 406 of FIG. 4.

In addition to the sensors 612, performance reports 614 can provide updates to the user model 522. As an, out of two best guess models 606 describing a user traveling home, “pattern of traveling to a same location at a same time every evening” has recently begun to consistently perform better than “arrive at home at 6:30 pm tonight”, so “pattern of traveling to a same location at a same time every evening” will replace “arrive at home at 6:30 pm tonight” as the model 522.

The performance reports 614 can include reasoning 616 and updated conditions for each model to determine model performance. The reasoning 616 can include generic reasoning such as a model “has recently begun to consistently perform better than” another model, or model-specific reasoning such as the behavior 526 of FIG. 5 is matching the best guess model 606 of “playing soccer rather than being in a meeting at work”.

The control flow 600 can provide the models 522 to a performance element 618 with updated conditions. The performance element 618 can apply priority such as the solution queue 544 of FIG. 5 or determine a query such as the user request module 546 of FIG. 5. The performance element 618 can further provide data to effectors 620 such as agents 542 of FIG. 5 configured to provide action on behalf of a user. Thus the control flow 600 prioritizes salient information when incorporating data into the model 522 such as updating conditions for each model 522 or the best model 522.

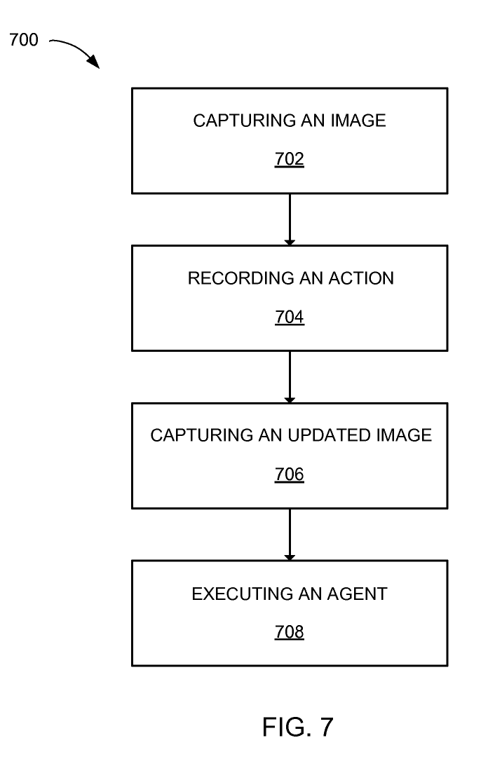

Referring now to FIG. 7, therein is shown a flow chart of a method 700 of operation of an electronic system 100 in an embodiment of the present invention. The method 700 includes: capturing an image in a block 702; recording an input associated with the image in a block 704; capturing an updated image in a block 706; and invoking an agent, with a control unit, associated with the updated image based on the input associated with the image in a block 708.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a communication unit configured to receive an image;
a user interface, coupled to the communication unit, configured to record an input associated with the image;
a storage unit, coupled to the user interface, configured to capture an updated image; and
a control unit, coupled to the storage unit, configured to invoke an agent associated with the updated image based on the input associated with the image.

2. The system as claimed in claim 1 wherein the storage unit is configured to determine a mood based on the image.

3. The system as claimed in claim 1 wherein the storage unit is configured to determine a user setting associated with the image.

4. The system as claimed in claim 1 wherein the control unit is configured to invoke the agent configured to determine a query.

5. The system as claimed in claim 1 wherein the control unit is configured to invoke the agent configured to act without a query.

6. The system as claimed in claim 1 wherein the control unit is configured to invoke the agent configured to access navigation resources.

7. The system as claimed in claim 1 wherein the control unit is configured to invoke the agent configured to access multimedia resources.

8. The system as claimed in claim 1 wherein the control unit is configured to invoke the agent configured to access consumer resources.

9. The system as claimed in claim 1 wherein the control unit is configured to invoke the agent configured to record a goal inferred based on the image.

10. The system as claimed in claim 1 wherein the control unit is configured to prioritize agents.

11. A method of operation of an electronic system comprising:
receiving an image;
recording an input associated with the image;
capturing an updated image; and
invoking an agent, with a control unit, associated with the updated image based on the input associated with the image.

12. The method as claimed in claim 11 further comprising determining a mood based on the image.

13. The method as claimed in claim 11 further comprising determining a user setting associated with the image.

14. The method as claimed in claim 11 wherein invoking the agent includes invoking the agent configured to determine a query.

15. The method as claimed in claim 11 wherein invoking the agent includes invoking the agent configured to act without a query.

16. The method as claimed in claim 11 wherein invoking the agent includes invoking the agent configured to access navigation resources.

17. The method as claimed in claim 11 wherein invoking the agent includes invoking the agent configured to access multimedia resources.

18. The method as claimed in claim 11 wherein invoking the agent includes invoking the agent configured to access consumer resources.

19. The method as claimed in claim 11 wherein invoking the agent includes recording a goal inferred based on the image.

20. The method as claimed in claim 11 wherein the control unit is configured to prioritize agents.
